(19) United States
(12) Patent Application Publication
(10) Pub. No.: US 2004/0093414 A1
(43) Pub. Date: May 13, 2004

(54) System for prevention of undesirable Internet content

(76) Inventor: Kevin R. Orton, San Clemente, CA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/648,430

(22) Filed: Aug. 25, 2003

Related U.S. Application Data
(60) Provisional application No. 60/384,604, filed on Aug. 26, 2002.

(51) Int. Cl. G06F 15/173

(52) U.S. Cl. 709/225

(57) ABSTRACT

A system for reducing or eliminating objectionable e-mails and other Internet content, including pornography. The system helps prevent undesired pornographic solicitations, thus helping free the personal computer user from the task of sorting and disposing of undesirable content. The system also provides increased protection against undesired pornographic Internet content for minors, and reduces unneeded Internet traffic. The system may include a content authorization processing device, a database, and an Internet data sender agreement. The system employs a unique domain name addressing system whereby senders of objectionable material may be put on notice prior to sending such material.

### PRIORITY INFORMATION

This application claims the benefit of U.S. Provisional Application No. 60/384,604 filed on Aug. 26, 2002.

### BACKGROUND AND SUMMARY

The Internet is a loosely coupled network of distributed computing systems. The network interface permits most any person to connect to the Internet, and to communicate with most any other person in the Internet. The connections require only common telephone cabling, and as such most any person from any continent or legal jurisdiction may connect to the Internet.

Various protocols exist for communication via the Internet, such as e-mail messages and web pages. E-mail messages are may be generated automatically by mechanized electronic machines such as computers, and so are a popular way of distributing messages.

However, in many cases, the sender of an e-mail message has only a casual or no relationship to the recipient of the e-mail message. As such, often times the sender of an e-mail message will send undesirable or even offensive or illegal material to the recipient of an e-mail message. Such undesirable or even offensive material may take the form of pornographic or other adult material or nudity. In many government jurisdictions, certain types of pornographic material are banned, while in other jurisdictions, they are permitted. Also, some recipients of e-mail messages may prefer to receive pornographic materiel, while others may not. As a user of the Internet, there is no way to determine if an incoming e-mail message is pornographic or not unless opening the message. But opening the message in itself may result in display of offensive material, and so the problem remains. The sender of a pornographic e-mail may not be breaking any laws locally, but the e-mail may contain material which is objectionable or even illegal for the recipient in another jurisdiction to posses. Further, pornographic pictures are also easily posted and sent through the Internet.

One method of dealing with this problem is by using spam blockers and filters. Such filters attempt to remove objectionable material in e-mails while the e-mail is in transit and before the e-mail reaches the user's computer. Such filters however are only partially effective in detecting and eliminating offensive e-mails, partly because the sender of the e-mail may change the format slightly so that blocking software no longer recognizes and blocks the e-mail. Thus there is a lot of time and money spent and wasted in trying to block undesired and/or pornographic e-mails and web pages. Thus it is desirable to more effectively prevent e-mails and Internet data with undesirable or offensive material.

### BRIEF DESCRIPTION OF THE DRAWINGS

FIG. 1 is an Internet address according to the prior art.

FIG. 2 is Internet address according to an embodiment of the invention.

FIG. 3 is a diagram showing Internet address processing events according to an embodiment of the invention.

### DETAILED DESCRIPTION OF THE PREFERRED EMBODIMENTS

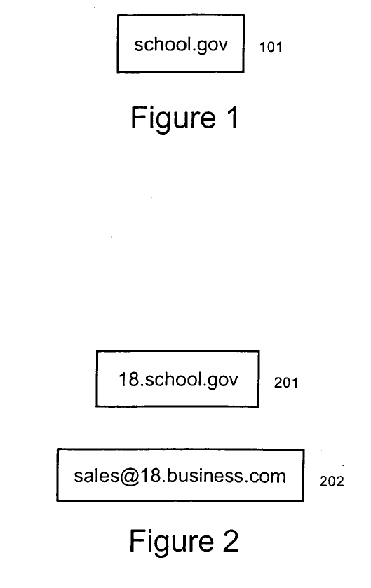

FIG. 1 shows a conventional Internet address. The specific domain name is “school”, and identifies the holder of the address with a name. The top level domain suffix is “le”, which may indicate that the name is used by a government entity.

More generally, a conventional Internet address typically contains a specific domain name indicating the holder of the specific domain, and one or more suffixes indicating classifications of the domain

FIG. 2 shows Internet addresses according to an embodiment of the invention. The unique name “school” is still in the address. The .gov suffix is still present. Added to the address is an additional portion. The additional portion contains an identifier “.18”. In 201 the .18 identifier is placed in the url (uniform resource locator) of an Internet address. 202 is an e-mail address which makes use of a domain with a .18 indicator.

The .18 indicator is promoted as being a novel indicator of protected legal status of a minor. When a .18 indicator is found as a portion of a web or e-mail address, the sender of an e-mail is put on notice ahead of time that the recipient is in a protected group.

In another embodiment, the .18 (pronounced “dot eighteen”) extension may be used as a prefix, suffix or add-on to a regular traditional e-mail address or domain name. For example, a user may have the e-mail address sue@hotmail.com and also use or have an e-mail address sue@hotmail.com.18. The .18 extension is publicly promoted as being reserved for minors and others who do not wish to receive pornographic material. The .18 suffix may be a specially designated nomenclature that enjoys government protected status. Any party may be free to use the .18 extension with their own Internet address. When a person uses the .18 extension as part of their e-mail or web address, it signals anyone that wishes to send an e-mail or a web page with adult content to that address that the holder of that address is or may be a minor, and does not wish to receive such material.

The .18 extension may be legislated by various government authorities in different jurisdictions such that any person or entity sending certain definable material to any e-mail address that contains a .18 extension is a guilty of a punishable act.

In an embodiment, the Internet backbone and domain name servers may be configured to recognize the specially designated .18 extension, and pass the e-mail through to the base address. Thus in this embodiment, there is no daily administration required to maintain the system, and any person is free to use the .18 extension any time they wish to do so.

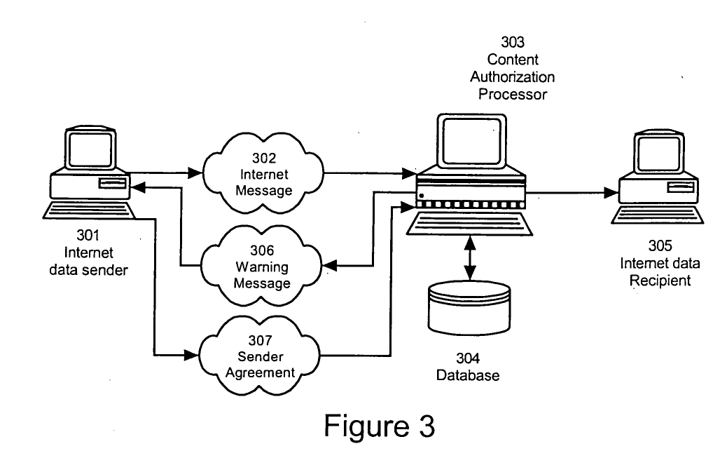

In a preferred embodiment, shown in FIG. 3, an Internet service provider (ISP) is registered to use a .18 or “minor” extension. In this case, the domain name of the service provider includes the “minor.” name. For example, the name “ISP.com” becomes “minor.ISP.com” or “school.gov” becomes “minor.school.gov” or “school.gov.18”. Adding the “minor.” prefix in front of the domain name is an example of a novel use of a third level domain name. Such third level domain addressing schemes are already provided for in the Internet system. The Internet routes the message as if the “minor.” prefix were not even present. Only when the message arrives at the recipient's ISP is the minor. prefix recognized and acted upon. Thus in one embodiment the system may be implemented with no change in current Internet standards.

The “minor.” enabled ISP may provide additional novel actions that further protect any person with a “minor.” name. The “minor.” enabled Internet service provider may operate computing equipment 303 that performs additional processing functions on a portion or all e-mail or web traffic that flows from an Internet data sender 301 through the Internet 302 to the ISP with content authorization processor 303 to an Internet data recipient 305. Internet data recipient 305 uses a “minor.” or .18 type designation. These additional processing functions may perform the function of content authorization processing. The content authorization processor 303 checks the web or Internet protocol (IP) address of the sender of any e-mail or web pages that pass through its servers. For example, if unknown Internet data sender bill@spam.com 301 with IP address 216.115.224.88, an Internet user, sends an e-mail addressed to st@minor.ISP.com. The ISP.com content authorization server 303 server checks a database 304 to see if bill@spam.com or IP address 216.115.224.88 has ever sent any e-mail or web pages to ISP.18.com before. If the message sender from IP 216.15.224.88 has never sent an message to ISP.18.com before, the ISP.18.com will then first send a warning notice 306 back to unknown Internet data sender with IP address 216.115.224.88 advising Internet user 216.115.224.88 that minor.ISP.com is a protected server and/or gateway, that the addressee is a minor or does not wish to receive such certain types of material, these certain types of material are not permitted, sending certain material to the server may be illegal, and the sender may be prosecuted. Such a message may be as shown below:

“Warning—The recipient specified in your e-mail is a minor under the age of 18 years old or has requested no pornographic material be sent to them. If your e-mail or web data contains pornographic material, you may be violating applicable laws. Do you wish to proceed?” (yes/no) “By checking yes you certify that this e-mail or web transmission contains no such objectionable material.”

The notice 306 may be in the form of an e-mail, a web page, or other Internet format. The .18 enabled ISP need only add a small amount of software to fully implement the system.

Internet data sender 301 will receive the warning message 306 and then be required to acknowledge that it received the notice and that Internet data sender 301 agrees to the terms of the .18 service. He does this preferably by manually entering a yes response on the keyboard. The yes acceptance response is then sent back to the content authorization processor 303, and is noted and/or recorded in the database 304. After receiving a yes response to the warning the ISP.18.com server will then pass the message or web page from the Internet data sender 301 to the Internet data recipient 305 (st@minor.ISP.com for example). Once the Internet data sender 301 has agreed to the terms of use of ISP.18.com, ISP.18.com may pass further messages from the Internet data sender 301 without further warning messages, or further warning messages may be occasionally sent to insure continuing compliance. The content authorization processor 303 may temporarily hold the message or data from data sender 301 while the content authorization processor 303 awaits a positive response 307 from Internet data sender 301 to the warning notice 306. If the Internet data sender does not agree or certify the material to not contain nudity or adult content, the e-mail or other web content from data sender 301 is deleted and not forwarded to data recipient 305.

In an alternative embodiment, the content authorization processor 303 is bi-directional. That is, after sender of Internet data 301 successfully sends a message 302 to Internet data recipient 305, Internet data recipient 305 then replies to the message, thereby becoming an Internet data sender. The content authorization processor 303 processes the reply is a similar manner as to the Internet message 302.

The domain name system (DNS) is a system using a database to link the numeric Internet protocol (IP) address of an Internet user with a text based name. Thus for example, Internet address 206.115.224.58 may be linked to business.com. The numeric (IP) portion of the name makes the system easier for computers to identify the user, and the text name portion makes it easier for humans to identify the user. A known computer called a domain name server allows someone with either just the text portion or just the numeric portion of a web or other IP address to look up and find the other corresponding portion. Thus when a sender of Internet traffic is identified only by their IP address, the content authorization processor 303 may do a lookup in the DNS server database, and determine the corresponding text value of the identity of the sender of an Internet message. The content authorization processor 303 then checks the text value for the .18 indicator, and makes a determination about forwarding the message. In one embodiment, a certain block of IP numbers, such as for example addresses ranging 206.115.221.1 to 206.115.221.255 are set aside and designated for reserved use just with .18 text names. Any IP address in this range automatically is associated with the .18 indicator, and the text portion of any Internet address within one of the designated ranges of IP numbers will automatically have the .18 designator in the text portion. Then, when content authorization processor 303 receives an Internet message 302 from any sender 301 destined for a recipient 305 within .18 designated IP ranges, the content authorization processor automatically handles the message as a .18 message, and no lookup to the domain name server is required.

Further information may be made available to recipients of the warning message 306, such as statues and/or definitions, to help them make the correct yes/no choice. The ISP may also operate a reporting service where users of the system may report violations of the agreement. Thus no person will accidentally send pornographic material to a person who does not wish to receive it. Further, a record is able to be maintained in database 304 whereby evidence may be made available for example to law enforcement authorities. The ISP is generally a third party, unrelated to either Internet user.

The system may be used along with known country code designators. For example, child23@minor.school.gov.us is an e-mail address for a minor in the Unites States territory.

Furthermore, operators of pornographic web sites may either voluntarily or by mandate configure their web servers so that they will automatically reject any inquiry or request from any person or computer address with a .18 code in their e-mail address or domain name. In this example, parents and other guardians may set up “.18” accounts for the minors, and the accounts are protected, for example by password, against bypassing by the minor. If the minor should send a request such as an e-mail or inquiry to a web site with pornographic materials, the web site will see the .18 designation in the url of the minor, and refuse to send the requested materials. Thus the system described herein provides a way for the sender of an e-mail or operator of a web site to know ahead of time that the requestor does not wish to receive material such as is being sent, before it is even sent, and that the sending of such material may even in fact be illegal. This then reduces the amount network clutter, and provides much easier administration for the e-mail user and more protected use by minors. The sender may cancel the transmission, or send a warning notice to the requester that the requester is not permitted access to that material.

In another embodiment, the content authorization processor 303 and the database 304 are located on the Internet data recipient computer 305.

In another embodiment, the warning message is a part of the Internet data sender software.

Businesses may also use the content authorization processor 303 to reduce undesired Internet traffic such as bulk, automated e-mails, and other network traffic. Bulk automated e-mail, often called spam, are generated by automatic addressing schemes, where multiple repeating messages are sent consecutively to different recipients in a fully automatic machine generated manner without human intervention or human generated individual addressing. The process is the same as when used by a minor to prevent pornographic material. Any time an Internet user sends traffic to an Internet recipient protected with the content authorization processor, the sender is sent a warning message with terms of use. The Internet data sender must then accept the terms of use before the Internet traffic is permitted to pass through. A record of the acceptance of the terms of use is then kept on file in a database accessible by the authorization processor, and checked each time new Internet traffic is sent.

The warning message preferably requires a manual yes/no type input on the keyboard or mouse of the sending computer, thus requiring human intervention before passing the message through. Alternative techniques may be used to help insure a manual yes/no input is provided in response to the warning message, thus reducing the chance for abuse by bulk e-mails senders. These techniques for instance require the user to manually type in a number in a picture before accepting the warning message reply. The particular techniques used are design choices for those skilled in the art.

Thus by perceiving a specific domain name, such as .18, in the domain name of an Internet data recipient, in advance, the sender of a pornographic e-mail or other material is put on prior notice that transmission of such pornographic material is illegal to send to the domain.

When a user signs up for an Internet account, they may either sign up for a conventional Internet account, or they may sign up for a .18 account. Both accounts are similar, except the .18 account has the .18 identifier tag in the name. Once a user signs up for a .18 account, all e-mail addresses and all web pages and other web traffic from and for that user automatically includes the .18 designation. The user of the account is thus protected against undesired material.

When a sender of spam material obtains a list of e-mail address to which to address their spam, there will be many names on the list. Some of the e-mail address may contain the .18 designator in the e-mail address. Software of the spam sender then sorts through the list of e-mail addresses, and if any pornographic material is being sent in the current spam, then addresses with the .18 designation are removed from the list by the software, such that the sending of the spam is blocked. Once the software is configured using known techniques to recognize the .18 designation, minimal or no further human intervention is required by the e-mail sender to prevent improper sending of undesired e-mails. Specifically, filter lists, blocking software, manual monitoring and other updates are not required.

The sender then has the option to cancel the message if the message is not appropriate. This may be done with a yes/no check box or other input means. Further, a copy of the authorization to send (the yes box checked by the sender) may be sent along with the e-mail.

The .18 designator in the url or e-mail address may be parsed and routed according to known techniques, allowing the message to be delivered as intended.

While an exemplary embodiment is described, numerous various substitutions and changes may be made, and still fall within the spirit and scope of the invention. For example, the .18 indicator is chosen by way of example only, and not limitation. Numerous other indicators, for example minor and child may also be used.

For additional example, other types of material other than pornographic material may be restricted to .18 addresses, such as cigarette advertising.

Additionally, with the domain name system used by the Internet, each domain name has a corresponding number associated with it. For example, business.com may have an IP address of 216.115.224.77. For example, sue@ISP.com is a text name, but the domain name system (DNS) also provides a numeric number for the name, for computer use. For example sue@ISP.com may be the domain name for Internet protocol (IP) number 206.115.224.3, or any such similar number. While the .18 designator is used with the text version of the name, a designator may likewise or alternately be used with the numeric version of the name. For example 216.115.224.77.18 or 206.115.224.3.18 Alternately, a specific group of numbers may be set aside and assigned to be used as .18 or “minor” numbers. For example, the range of numbers of 216.115.224.1-216.115.224.255 may be designated as reserved for use by minors. In this case, anyone sending a pornographic e-mail to any of the designated addresses would be in violation of the standards. In this case, the domain name system (DNS) may automatically append the .18 or minor name to any number within the designated range. The sender of an Internet message, having only either the IP address or the domain name, can determine the associated corresponding IP address or domain name by doing a lookup on a domain name server or other database.

Because the .18 designator is in the address of the recipient of the e-mail or web page, the sender is able to know ahead of time that the recipient is a minor, and may be more subject to and prosecutable for various local pornography laws than would otherwise be the case. Further, specific legal content standards may be developed for use in .18 name extensions. Thus the system provides a viable and effective of reducing or eliminating undesirable Internet content, and provides for a safer computing environment for minors.

The system may be used equally effectively on e-mails, web pages, or other Internet traffic, and is meant for all types of Internet traffic using both current and future communication protocols.

What is claimed is:

1. An Internet addressing scheme for the prevention of sending undesired material comprising a certain partial portion, wherein the certain partial portion of a recipient address is assigned a designated indicator value, said designated indicator value being publicly promoted as a class of service.

2. A scheme as in claim 1, wherein said class of service of the designated indicator value in said partial portion of a recipient address is publicly promoted and designated as for use by minors.

3. A scheme as in claim 2, wherein the designated indicator value in the partial portion of a recipient address is publicly promoted and designated as for use by minors, with legal penalties attached for addressing undesired material to any such address.

4. A scheme as in claim 3, wherein the recipient address is held by a minor.

5. A scheme as in claim 1 wherein said certain partial portion of the recipient address is appended onto the end of a conventional Internet address.

6. A scheme as in claim 1 wherein said certain partial portion of the recipient address is embedded within a conventional Internet address.

7. A web server comprising a request checker module server that checks the url of incoming requests for web pages, and a request blocker module that does not send the requested page if the url of the incoming request contains a certain publicly promoted value designated as for use by minors and the requested page is unsuitable for minors.

8. A content authorization server comprising an address checker module that checks a recipient Internet address of Internet traffic passing through the server for a designated indicator value in a partial portion of an Internet address publicly promoted as being for use by minors, and a warning message sender module that receives the results of the check performed by the address checker module, if such a designated indicator value is found, sends a warning message to a sender of the Internet traffic.

9. A content authorization server as in claim 8, wherein said sender of said Internet traffic is required to accept a term of use outlined in said warning message before Internet content will be delivered to the recipient Internet address.

10. A content authorization server as in claim 9, further comprising a database, wherein a record is kept in the database each time the sender of the Internet traffic agrees to the term of use.

11. A content authorization server as in claim 10, further comprising a traffic blocker module that blocks transmission of the Internet traffic unless a record of agreement is found in said database.

12. An Internet addressing scheme for the prevention of sending bulk automated messages comprising a certain partial portion, wherein the certain partial portion of a recipient address is assigned a designated indicator value which is publicly promoted as being designated as a certain class of service when said designated indicator value is included in said portion.

13. A method as in claim 12, wherein said designated indicator value in said partial portion of a recipient address is publicly promoted and designated as for use by those not wishing to receive bulk automated messages.

14. A method as in claim 12 wherein said designated indicator value in the partial portion of the recipient address is publicly promoted and designated as for use by those not wishing to receive bulk automated messages, with penalties attached for addressing such messages to any such address.

15. A method as in claim 12 wherein said certain partial portion of the recipient address is appended onto the end of a conventional Internet address.

16. A method as in claim 12 wherein said certain partial portion of the recipient address is embedded within a conventional Internet address.

17. A content authorization server comprising an address checker module that checks a recipient Internet address of Internet traffic passing through the server for a designated indicator value in a partial portion of an Internet address publicly promoted as being for use by those not wishing to receive bulk automated messages, and a warning message sender module that receives the results of the check performed by the address checker module, if such a designated indicator value is found, sends a warning message to a sender of the Internet traffic.

18. A content authorization server as in claim 17, wherein said sender of said Internet traffic is required to accept a term of use outlined in said warning message before Internet content will be delivered to the recipient Internet address.

19. A content authorization server as in claim 18, further comprising a database, wherein a record is kept in the database each time the sender of the Internet traffic agrees to the term of use.

20. A content authorization server comprising an address checker module which checks the Internet address of a sender of incoming Internet traffic, a database verification module that looks up said sender address in a database, and a warning message sender module that receives the results of the check performed by the address checker module, that sends a warning message to the sender of said incoming Internet traffic if the Internet address of the sender of said Internet traffic is not found in said database.
